(19) United States
(12) Patent Application Publication
(10) Pub. No.: US 2012/0206567 A1
(43) Pub. Date: Aug. 16, 2012

(54) SUBTITLE DETECTION SYSTEM AND METHOD TO TELEVISION VIDEO

(75) Inventors: Bahman Zafarifar, Eindhoven (NL); Jingyue Cao, Eindhoven (NL)

(73) Assignee: TRIDENT MICROSYSTEMS (FAR EAST) LTD., Grand Cayman (KY)

(21) Appl. No.: 13/231,891

(22) Filed: Sep. 13, 2011

Related U.S. Application Data
(60) Provisional application No. 61/382,244, filed on Sep. 13, 2010.

(51) Int. Cl. H04N 7/025; H04N 13/00

(52) U.S. Cl. 348/42; 348/465; 348/E07.017; 348/E13.001

(57) ABSTRACT

A sub-title detection system and method for television video are provided in which a static region detection is performed, and the results of the static region detection are pruned using a feature based on density of horizontal transition pairs, an intelligent adaptive temporal filtering is performed that uses object-level subtitle information and has suitable properties for integration in a streaming video environment, rectangular bounding boxes are computed around the subtitle using height, width and filling-degree constraints, and finally, subtitle bounding boxes are identified by binary classification based on text stroke alignment features.

### PRIORITY CLAIMS/RELATED APPLICATIONS

This application claims the benefit under 35 USC 119(e) and 120 of U.S. Provisional Patent Application Ser. No. 61/382,244 filed on Sep. 13, 2010 and entitled “Subtitle Detection to the Television Video,” the entirety of which is incorporated herein by reference.

### FIELD

The disclosure relates generally to the detection of subtitle and in particular to the detection of subtitles in video.

### BACKGROUND

Among visual, audio and textual information present in a video sequence, text provides condensed information in understanding the content of video and thus plays an important role in browsing and retrieving video data. Subtitle is one of the text information, which draws researcher's attention; massive efforts have been made for subtitle detection and recognition. However, it is not trivial to reliably detect and locate subtitles embedded in images. The font, size and even color of subtitles could vary in different videos; subtitle could appear and disappear in arbitrary video frames; and the background video could be complex and changing, independent of the subtitle.

Methods for subtitle detection applied on a single frame of video sequences, could be generally categorized into connect-component-based analysis, texture-based analysis and edge-based analysis. Known methods based on connected-component analysis use the uniformity of text as a distinguishing feature. Typically, it is usually combined with color-based analysis, which is based on the assumption that text is presented with a uniform color. After color quantization, the connected components with homogeneous color, which further conform to a certain size, shape and spatial alignment constraints, are extracted as text. In C. Garcia and X. Apostolidis, “Text detection and segmentation in complex color images,” Proceedings of the Acoustics, Speech, and Signal Processing. 2000. on IEEE International Conference—Volume 04, IEEE Computer Society, 2000, pp. 2326-2329, Garcia performs connected component analysis on the edge map derived by recursive Deriche edge detector. In Soo-Chang Pei and Yu-Ting Chuang, “Automatic text detection using multi-layer color quantization in complex color images,” Multimedia and Expo, 2004. ICME '04. 2004 IEEE International Conference on, 2004, pp. 619-622, Soo-Chang Pei applies neural network for color quantization and 3D histogram analysis for color candidate selection and then perform connectivity analysis and morphological operation to produce text candidates. Connected-component-based methods are efficient, yet would run into difficulties when the background is complex or the text is noisy, degraded, textured and touching other graphical objects.

Texture-based analysis treats the text-region as texture, because it is known that text regions possess a special texture due to high contrast of text versus background and a periodic horizontal intensity variation. For example, in Y. Zhong, H. Zhang, and A. K. Jain, “Automatic Caption Localization in Compressed Video,” IEEE Transactions on Pattern Analysis and Machine Intelligence, vol. 22, 2000, pp. 385-392, Zhong uses the coefficients of Discrete Cosine Transform to capture the directionality and periodicity of local image blocks as texture properties and then based on this properties detect the text region. In Xueming Qian and Guizhong Liu, “Text Detection, Localization and Segmentation in Compressed Videos,”Acoustics, Speech and Signal Processing, 2006. ICASSP 2006 Proceedings. 2006 IEEE International Conference on, 2006, p. II, Qian et al. also uses the DCT coefficients to compute text boxes using vertical and horizontal block texture projections. Wu et al. [10] implement linear and nonlinear filtering, nonlinear transformation and k-mean clustering to derive texture feature for text detection. In K. I. Kim, K. Jung, and J. H. Kim, “Texture-Based Approach for Text Detection in Images Using Support Vector Machines and Continuously Adaptive Mean Shift Algorithm,” IEEE Trans. Pattern Anal. Mach. Intell., vol. 25, 2003, pp. 1631-1639, Kim et al. adopts a support vector machine to do texture classification. In general, texture-based method performs better than connected-component based method in dealing with complex background. However, the texture-based methods find difficulties when the background display similar texture structures as the text region.

Edge-based analysis has been also widely used in text extraction, since characters are composed of line segment and have sharp edges. In Congjie Mi, Yuan Xu, Hong Lu, and Xiangyang Xue, “A Novel Video Text Extraction Approach Based on Multiple Frames,” Information, Communications and Signal Processing, 2005 Fifth International Conference on, 2005, pp. 678-682, Congjie Mi et al. detects edges by an improved Canny edge detector accompanied with text line features. In H. Li, D. Doermann, and O. Kia, “Automatic text detection and tracking in digital video,” Image Processing IEEE Transactions on, vol. 9, 2000, pp. 156, 147, Li et al. adopts wavelet decomposition to detect edges in high frequency sub-bands. In C. Liu, C. Wang, and R. Dai, “Text Detection in Images Based on Unsupervised Classification of Edgebased Features,” Proceedings of the Eighth International Conference on Document Analysis and Recognition, IEEE Computer Society, 2005, pp. 610-614, Liu et al. detect edges with Sobel edge operator in four directions (horizontal, vertical, up-right and up-left). In G. Guo, J. Jin, X. Ping, and T. Zhang, “Automatic Video Text Localization and Recognition,” Image and Graphics, International Conference on, Los Alamitos, Calif., USA: IEEE Computer Society, 2007, pp. 484-489, Guo et al. implements Susan edge detector to derive corner point response. These edge-based methods are effective in segmenting text after text bounding boxes are already located, but are less reliable when applied to the entire frame since other objects in the scene could also possess strong edges.

Besides the above techniques applied on individual frames independently, there are techniques which take the temporal information into account based on multiple frames of video. These techniques are exploited to overcome the complexity of background using static location of subtitle/text, which means the subtitle would stay in the same position for many consecutive frames. In Xian-Sheng Hua, Pei Yin, and Hong-Jiang Zhang, “Efficient video text recognition using multiple frame integration,” Image Processing. 2002. Proceedings. 2002 International Conference on, 2002, pp. II-397-II-400 vol. 2, Hua et al. utilizes multiple frame verification and high contrast frame averaging to extract clear text from very complex background. In Congjie Mi, Yuan Xu, Hong Lu, and Xiangyang Xue, “A Novel Video Text Extraction Approach Based on Multiple Frames,” Information, Communications and Signal Processing, 2005 Fifth International Conference on, 2005, pp. 678-682, Congjie Mi et al. compares the similarity of both text region and edge map to determine the start and end frame containing the same object for multiple frame integration, and refines the text regions by reapplying text detection on a synthesized image produced by minimum/maximum pixel search on consecutive frames. In C. Wolf, J. Jolion, and F. Chassaing, “Text Localization, Enhancement and Binarization in Multimedia Documents,” Pattern Recognition, International Conference on, Los Alamitos, Calif., USA: IEEE Computer Society, 2002, p. 21037, Wolf et al. develops an algorithm of bi-linear interpolation using multiple frames for text enhancement. In X. Tang, X. Gao, J. Liu, and H. Zhang, “A spatial-temporal approach for video caption detection and recognition,” IEEE Transactions on Neural Networks/a Publication of the IEEE Neural Networks Council, vol. 13, 2002, pp. 961-971, Tang et al. chooses a self-organizing neural network to segment the video sequence into camera shots and then compute the histogram and spatial difference to detect the shot boundary for multiple integration. In Bo Luo, Xiaoou Tang, Jianzhuang Liu, and Hongjiang Zhang, “Video caption detection and extraction using temporal information,” Image Processing, 2003. ICIP 2003. Proceedings. 2003 International Conference on, 2003, pp. 1-297-300 vol. 1, Luo et al. proposes a method to segment video text using temporal feature vectors to detect the appearance and disappearance of subtitles.

Other works on subtitle/text detection, localization and extraction adopt similar analysis techniques mentioned above, but differ in combination methodology and processing sequence.

As described in B. Penz, “Subtitle Text Detection and Localization in MPEG-2 Streams,” 2002, subtitles have the following characteristics: size, contrast, color, geometry, temporal uniformity, and overlay.
Size: There is a minimum size for subtitle characters because the subtitle is supposed to be read by the viewer from the typical viewing distance, within limited time. On the other hand, there is also a maximum size for the characters because the subtitle should not span the whole screen. Characters of different subtitles can have various sizes and fonts.
Contrast: Contrast between text and background is usually high. Even if the characters of the subtitle are white and appear on a white background, a surrounding black border makes them distinguishable from background, and therefore still readable.
Color: Typically, characters in a single subtitle have similar color. In general, they are light with a small surrounding dark border. Some of the text pixels may share the color of the background.
Geometry: Text belonging to a subtitle is horizontally aligned. Also the aspect ratio of the entire subtitle lies in a certain range.
Temporal Uniformity: Because the viewer needs certain time to read the subtitle text from the screen, subtitle text retains for a minimum amount of time. Furthermore, subtitle text does not move during this time.
Overlaid: Subtitle text is overlaid on top of the video frame. The background of the subtitle can be non-uniform, rapidly changing and subject to interlacing.

Based on the above subtitle characteristics, the multitude of features subtitle possess, such as high contrast between text and background, font size limitation, geometry and aspect ratio of the subtitle text area, uniform color and temporal uniformity, could be utilized for subtitle detection and localization. However, reliable detection may still prove to be difficult in practice. For example, despite the rule of thumb on the size, the fonts and sizes can vary a lot; some text pixels might share the color of the background, which lowers the contrast; the background is non-uniform, rapidly changing, and might contain similar features as subtitle. Therefore, it is desirable to provide a method that carefully considers the merit of using each feature, and its effect on the performance of the detection result.

The current static region detection algorithm uses pixel-level information such as high-contrast transitions in the luminance channel, and the stability of their spatial location over multiple video frames. This detection algorithm complies with the temporal uniformity of subtitles such that nearly all subtitle areas are detected. However, the simplicity of this algorithm causes that the detection result contains significant amount of false positives (non-subtitle regions being detected as subtitle). These excessive false positives are due to the following reasons.
Besides subtitles, many other high-contrast stationary objects may appear in an image. An algorithm relying only on this information classifies all these objects as subtitles.
Patterns with high spatial frequency, such as horizontally moving black-and-white vertical stripes, may appear static when the pattern moves with a speed that spatially aligns repetitions of the pattern from frame to frame. A static region detector that operates at pixel level may falsely detect this pseudo-stationary region as static.
There are certain disadvantages of static region detector in detecting subtitle region in the start and especially the end frame of a subtitle. When the subtitle appears or disappears, the static region detector can no longer well preserve the subtitle region.
Using a simple pixel-level temporal uniformity, changes in the background luminance may cause the output of the static region detection on subtitle borders to vary from frame to frame. A more reliable result may be achieved if temporal uniformity (existence of the subtitle over many frames) is verified (averaged) over the entire subtitle area.

Despite the above shortcomings, the current algorithm is a good starting point for subtitle detection, since the majority of subtitle regions are detected. Therefore, it is desirable to provide a system and method for detecting subtitles in a way that achieves a true positive rate similar to the current static region detection algorithm (nearly all subtitle regions are detected), while obtaining a lower false positive rate (reject more non-subtitle areas).

Thus, it is desirable to provide a system and method for detecting and localizing subtitles from real-time accessing videos based on the detection of a static region and other subtitle-specific features and it is to this end that the disclosure is directed.

### BRIEF DESCRIPTION OF THE DRAWINGS

FIG. 1 illustrates a subtitle detection method;

FIGS. 2(a) and (b) illustrate a static region detection input image and output, respectively;

FIGS. 3(a)-(c) illustrate horizontal luminance variation;

FIGS. 4(a)-(b) illustrate the definition of a transition pair;

FIGS. 5(a)-(c) illustrate pruning a static region map;

FIG. 6 illustrates a bounding box computation and preliminary categorization;

FIGS. 7(a)-(e) illustrate a first bi-projection operation and results;

FIGS. 8(a)-(d) illustrate an iterative bi-projection of the method;

FIGS. 9(a)-(c) illustrate fixed thresholding;

FIGS. 10(a)-(e) illustrate the computation of an adaptive threshold;

FIG. 11 illustrates a comparision between a fixed and adaptive threshold;

FIG. 12 illustrates a bounding box computed using iterative bi-projection and adaptive thresholds;

FIGS. 13(a)-(c) illustrate adaptive temporal filtering;

FIGS. 14(a)-(f) illustrate an example of adaptive temporal filtering;

FIGS. 15(a)-(b) illustrate horizontal transition pairs used for pruning a static region map;

FIGS. 16(a) and (b) illustrate examples of convolution kernels for measuring alignment for alignment of transition pairs;

FIG. 17(a)-(c) illustrates a text stroke alignment feature;

FIG. 18 illustrates a distribution of text stroke alignment features in a training set;

FIG. 19 illustrates a receiver operating characteristic of a training set;

FIG. 20 is a graphic illustration of a binary classifier;

FIGS. 21(a) and (b) illustrates two exemplary misclassified subtitle bounding boxes;

FIGS. 22(a) and (b) are a bounding box computation on moving zoneplates test pattern; and

FIG. 23 illustrates a system that implements the subtitle detection method.

### DETAILED DESCRIPTION OF ONE OR MORE EMBODIMENTS

The system and method are described and illustrated in the context of a subtitle detection system and method implemented in a device that detects subtitles in a digital television signal and it is in this context that the system and method are described. However, the subtitle detection system and method may be implemented in other types of display devices (including analog television devices), may be implemented on a stand-alone computer or other implementations. In addition, while the implementation below in a hardware device (a controller chip in a television analysis unit or a controller in a television receiver or television set top box) that executes code (firmware or the like) to implement the subtitle method described below, the system may also be implemented solely in software and then executed on a processing unit based device or in a combination of hardware and software.

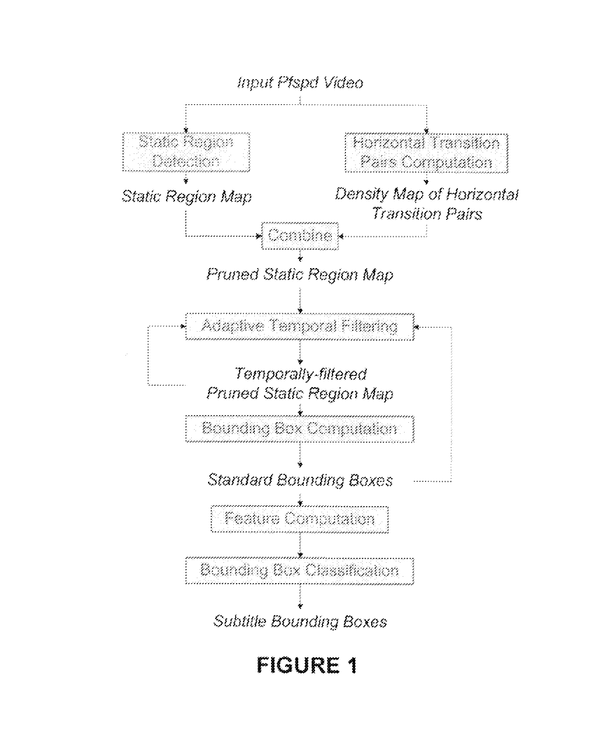

A subtitle detection system and method is illustrated in FIG. 1. The method starts with the existing static region detection process, and prune its results by combining it with a feature based on the density of horizontal transition pairs. This feature computes horizontal transition pairs and selects regions that have a high density of transition pairs. Next, the method performs adaptive temporal filtering on the pruned static region map which integrates the information of the pruned static region map in each image area using an appropriate area-specific filter characterized by whether the region had been detected in previous frames as potential subtitle. The method then performs a bounding box computation, which roughly locates candidate subtitle areas by a rectangle, using height, width and filling-degree constraints. The method then computes, for each bounding box, a horizontal and a vertical text stroke alignment feature and establish a binary classifier that uses these features to identify the bounding boxes that contain subtitles.

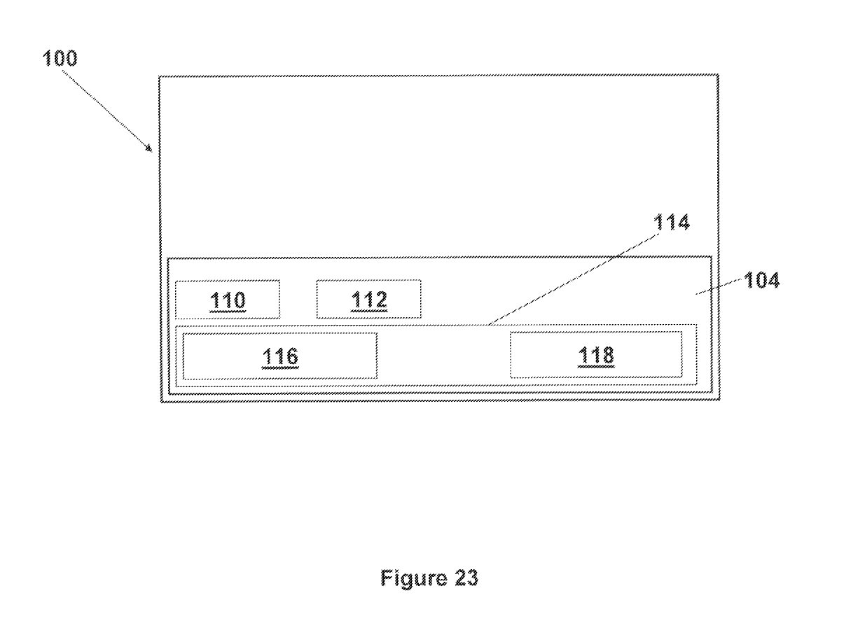

FIG. 23 illustrates an example of a system that implements the subtitle detection method. In this example, the system is a television analysis device 100 that incorporate the subtitle detection method described below. The television analysis device 100 has a controller chip 104 that controls the overall operations of the television analysis device. The controller chip 104 may further comprise one or more processing units/cores 110, an operating system/firmware 112 and a memory 114 that contains one or more modules 116, 118 that implement the subtitle detection method in which the subtitle detection processes are performed by software. In an alternative embodiment, the subtitle detection system may be implemented in one or more hardware circuits that include a static region detector, an adaptive filtering unit and a bounding box classifier.

Now, returning to the method of subtitle detection, a process for pruning a static region map is described.

Pruning the Static Region Map

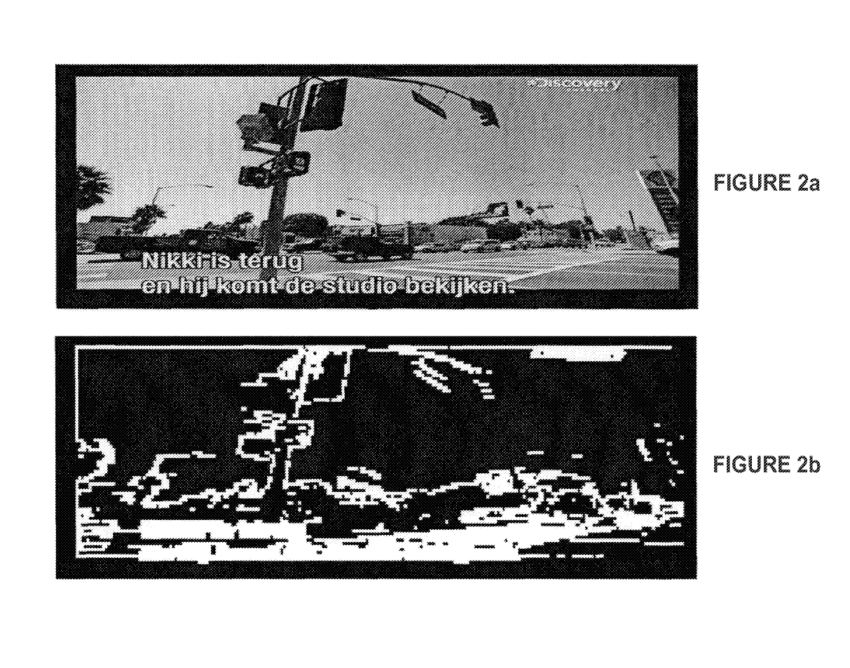

The existing static region detector classifies strong edges (in the luminance channel) that remain at the same spatial location over a few frames. Since this simple detector finds nearly all subtitle areas and thus can be taken as a good starting point for subtitle detection. However, not only subtitles, but also many other objects in an image are stationary. FIG. 2 shows an image (FIG. 2a) and its corresponding static region map (FIG. 2b), where the whole scene except for the moving cars is stationary. It can be seen that the static region detector includes all the strong edges of stationary objects into the static region map, which makes subtitle detection difficult.

To make things worse, the static region detector might also capture pseudo-stationary region like moving black-and-white stripes. Hence, before making use of the static region map, we need to perform some form of pruning on this map, using subtitle-specific features other than stationary strong edges.

For pruning the static region map, we propose a method based on spatial density of horizontal transition pairs, computed in the luminance channel of the input image. Only areas on the static region map that coincide with a high density of the above-mentioned transition pairs are accepted as pruned static regions. This method of pruning is based on the observation that subtitles are in strong contrast to the background. Subtitles typically have bright colors and are surrounded by a dark border, in order to make them distinguishable in bright or dark backgrounds. The method only requires image information of a single frame.

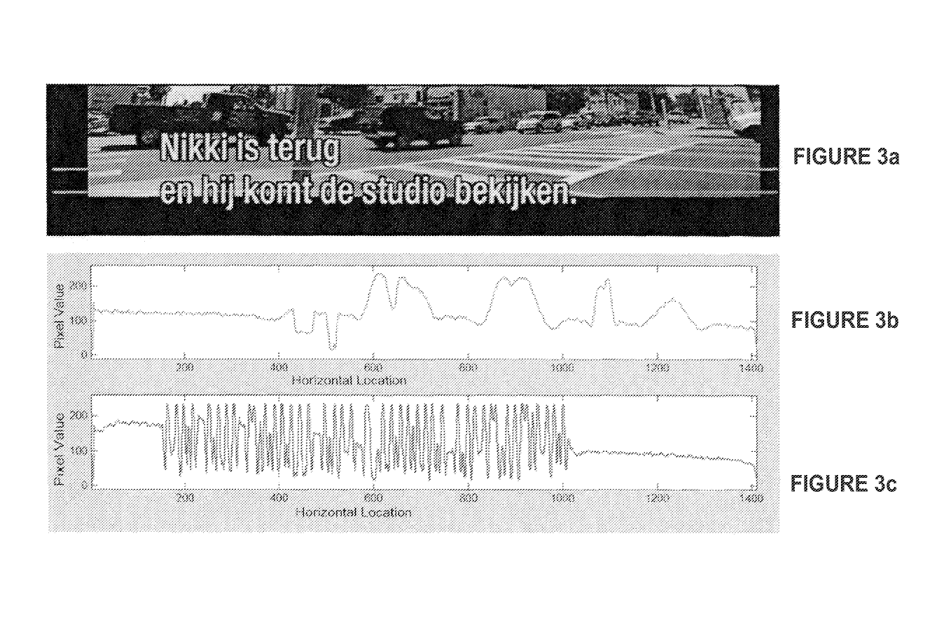

In FIG. 3, we show two lines from an image (FIG. 3a) and visualize their luminance variation. The pink line is a randomly selected line (FIG. 3b), while the blue line goes through the subtitle region. Compared to the pink line, the blue line shows luminance fluctuations with high spatial intensity (FIG. 3c), a feature that we will use for pruning the static region map.

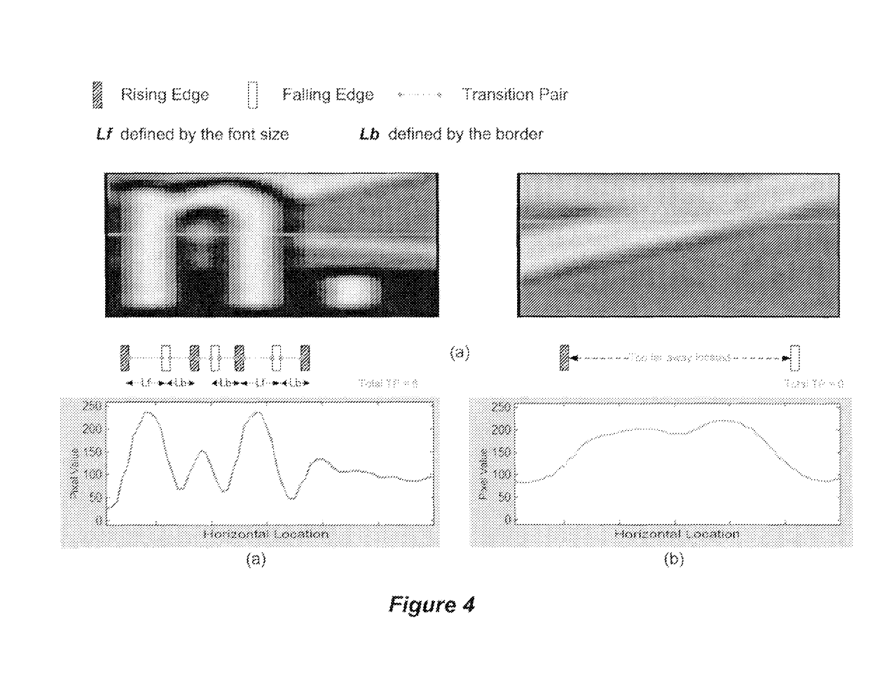

The method defines a ‘Transition Pair’ as a pair of closely located falling-followed-by-rising edges, or a pair of rising-followed-by-falling edges. FIG. 4 illustrates how the method defines a transition pair with (a) A horizontal line going through letter ‘n’ contains many closely-located rising and falling edges (FIG. 4a); six transition pairs are calculated (FIG. 4b) and some part of the zebra crossing (FIG. 4c) has too far away located rising and falling edges and thus has zero transition pairs.

The pruning is implemented by the following procedures.

a. Apply a horizontal gradient filter on the input image to localize sharp rising and falling edges. Sharp is quantified as the gradient of luminance bigger than 20 over two horizontally adjacent pixels.

b. Find closely-located rising and falling edges and mark them as transition pairs (we use both rising-followed-by-falling and falling-followed-by-rising edge pairs). Denote a transition point for each transition pair as the middle of corresponding rising and falling edges.

c. Calculate the density of transition pairs with block size of 12×12, by counting the number of transition pairs within the block.

d. Select the region with high density of horizontal transition pairs, and apply dilation to also admit its surrounding regions that have a lower density of horizontal transition pairs. We denote the output of this step as density map of horizontal transition pairs.

e. Combine the density map of horizontal transition pairs with the static region map to create pruned static region map. Combining is implemented by a logical AND function.

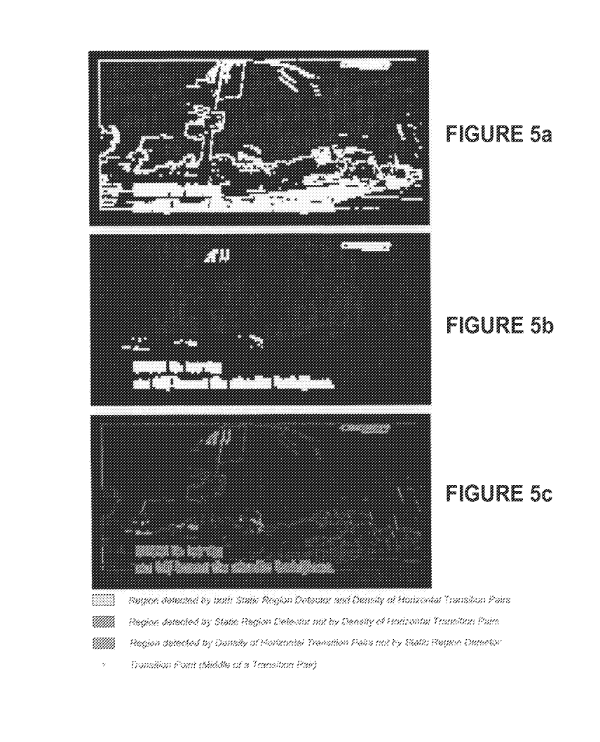

FIG. 5 shows the pruned static region map of the input image which was shown in FIG. 2. In particular, FIG. 5a is a static region map, FIG. 5b is a pruned static region map (Most non-subtitle areas are rejected) and FIG. 5c is the combining process of static region map and density map of horizontal transition pairs.

Compared to the result of the static region detector, it can be seen that the adoption of the above method is effective in eliminating the static regions corresponding to the non-subtitle background. The pruned static region map can now undergo further processing for subtitle detection.

Bounding Box Computation

Before introducing adaptive temporal filtering, we first describe the details of bounding box computation. In the Adaptive Temporal Filtering section below, an explanation is provided about the adaptive temporal filtering, which is based on the result of bounding box computation of previous frames.

A subtitle bounding box delimits the smallest rectangle that encompasses a subtitle area. Bounding box computation relies on properties such as the distance between characters and words, and height and width of the subtitle. The method uses iterative bi-projections of a temporally filtered version of the pruned static region map. For brevity, the notion of temporally filtered in the remaining of section is omitted, so where we say pruned static region map, we mean temporally filtered, pruned static region map.

Below is an overview of the steps involved in bounding box computation, and then each step is explained in more detail.

Overview of Operations for Bounding Box Computation

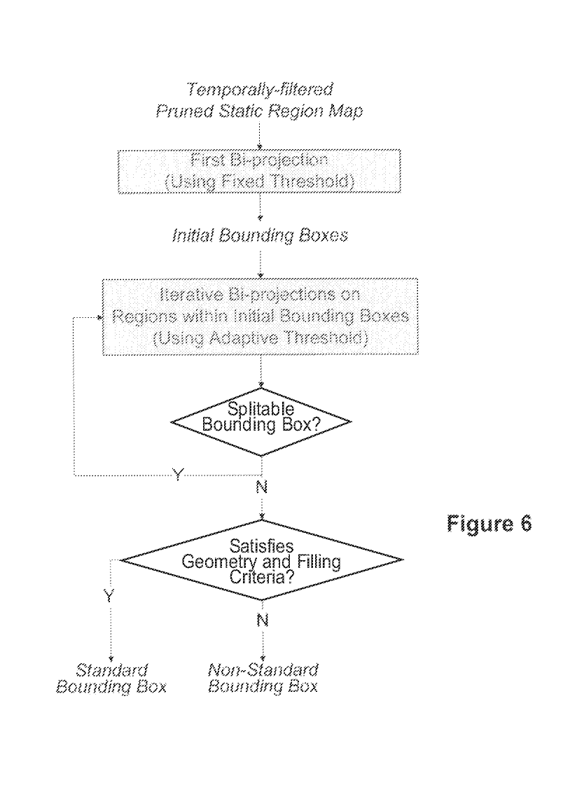

Bounding box computation starts (FIG. 6) with a first bi-projection of the pruned static region map using fixed thresholds, resulting to initial bounding boxes. In the next step, the pruned static region map within each initial bounding box is subjected to further iterative bi-projections that use an adaptive threshold, which increases the accuracy of the bounding boxes. This iteration stops if the bounding boxes can no longer be split. In the next step, each bounding box is categorized to standard or nonstandard, based on geometry properties and the filling degree of pruned static regions within the bounding box.

First Bi-Projection with Fixed Thresholding

The first step of bounding box computation is bi-projection of the pruned static region map. Bi-projection computes the sum of the pixel values of an image first in the horizontal direction, and then in the vertical direction, resulting to two I-dimensional arrays of values (histograms). The method computes the sum of pixels that are indicated as static in the pruned static region map.

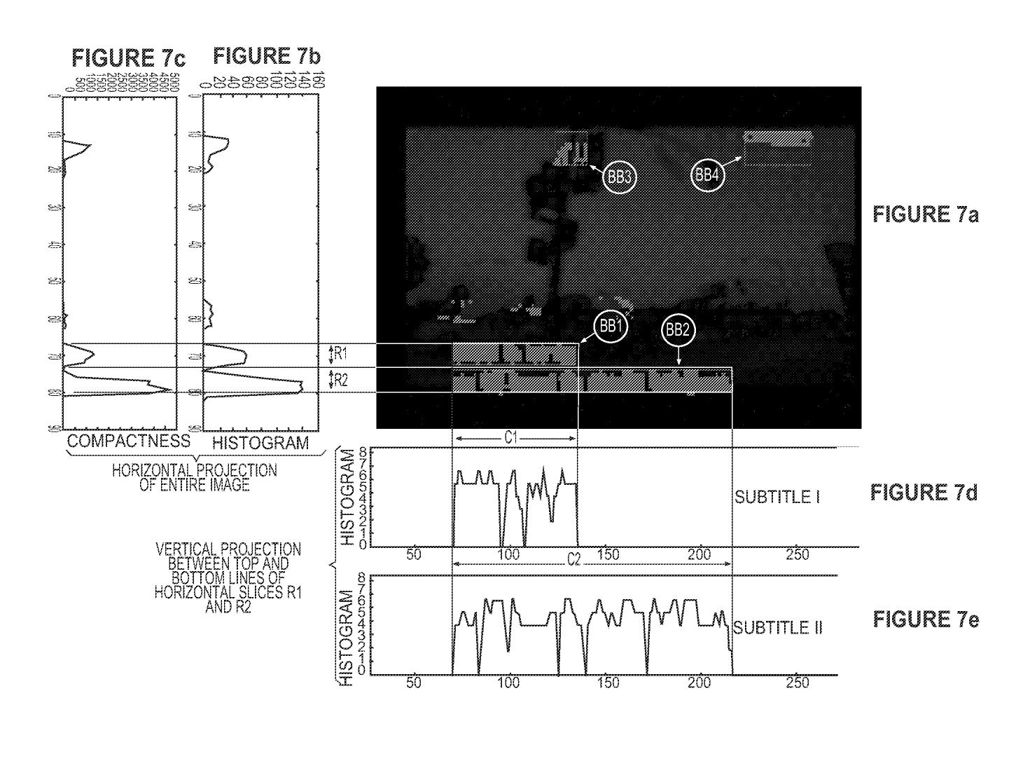

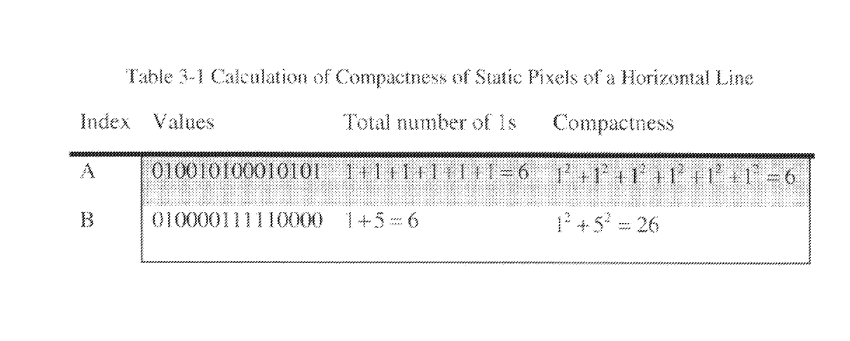

FIG. 7 shows the result of bi-projection of the pruned static region map of the image shown in FIG. 2.

FIG. 7(a) shows the pruned static region map in gray, and the bounding boxes computed on the image in green. Let us consider the pruned static regions (the gray pixels) to have a value of 1, and the rest of the image to have a value of 0. The process of bi-projection is described in more detail below.

The first step is to perform a horizontal projection. For horizontal projection, we calculate two values for each line: the number of pruned static pixels (1s) and the compactness of the static pixels on the line (shown in FIG. 7(b), and (c), respectively). The compactness measure is an indication of how pruned static pixels are clustered, i.e. densely or sparsely. The compactness is measured by calculating the length of each contiguous series of 1s, raising this length to power 2, and summing up these squared lengths.

This is illustrated in Table 3-1, where series A and series B have the same amount of pruned static pixels (with value 1) but series B is more densely clustered. The value of the compactness measure is generally higher for subtitle regions as compared to other regions, and can therefore be used for eliminating sparsely spaced static regions.

Employing both histogram and compactness, the method applies fixed thresholds to select regions with high value in both histogram and compactness. These regions (R1 and R2 in FIG. 7) correspond to images lines that contain horizontally coherent areas in the pruned static region map. The selected regions may be labeled with the position of the top line and the bottom line.

The second step is to perform a vertical projection on each of the above-mentioned selected regions (shown by the two histograms in FIGS. 7 (d), and (e)). Now, the method applies thresholding on the obtained histograms (using fixed threshold levels) to select vertically coherent areas in the pruned static region map. The method allows for a certain discontinuity in the histogram in vertical projection, to account for the gap between subtitle words, and facilitate computing bounding a box that contains all the words of a subtitle line. After vertical projection, we label each separated region with the indices of its top, bottom, left and right positions. This marks the position of the corresponding bounding box in the image.

In FIG. 7, the above bi-projection procedure produces four bounding boxes (BB1, BB2, BB3 and BB4). It can be seen that the vertical delineations of BB3 and BB4 are inaccurate (the bounding boxes are taller than the inscribed pruned static regions), which is an inherent limitation of a single pass bi-projection. Therefore, the method introduces an iterative bi-projection procedure, in order to improve the accuracy of the computed bounding box. This procedure is further described below.

Iterative Bi-Projection

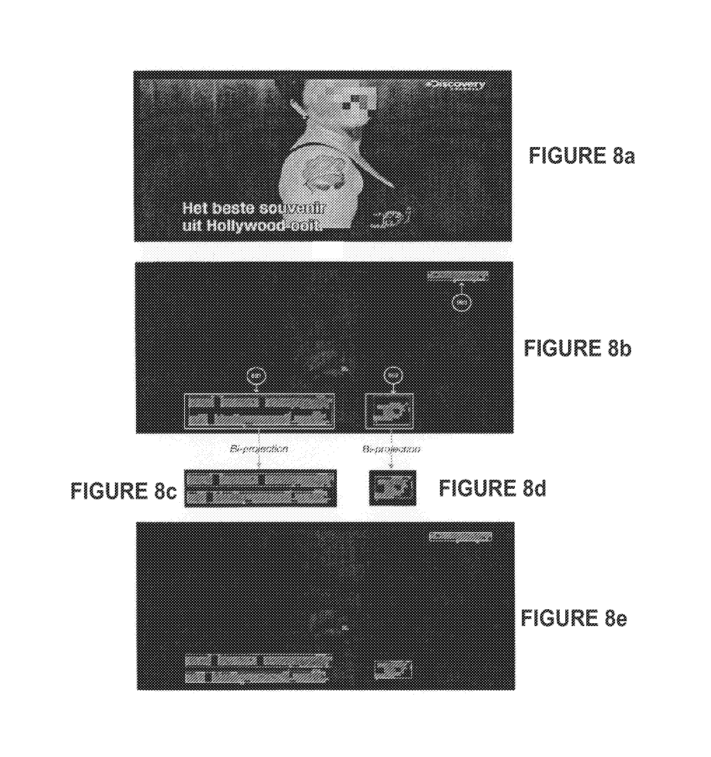

FIG. 8 (b) shows the bounding boxes resulting from the first iteration of bi-projection procedure. It can be seen that the first iteration has not been able to separate the two subtitle lines and has computed only one bounding box BB1 that contains both subtitle lines. In addition, the bounding box BB2 is larger than the size of the inscribed pruned static regions.

After the first iteration of bi-projection, method applies a second iteration of bi-projection on the region bounded by the each bounding box (as if each part were a small input image), in order to determine whether the content can be separated to individual bounding boxes with higher precision of spatial positions. FIG. 8 (e) shows that result of the second iteration of bi-projection separates the two subtitle lines, and reduces the bounding box size corresponding to BB2 in FIG. 8 (b). The above procedure is iteratively carried out until region undergoing bi-projection can no longer be split.

Adaptive Thresholding

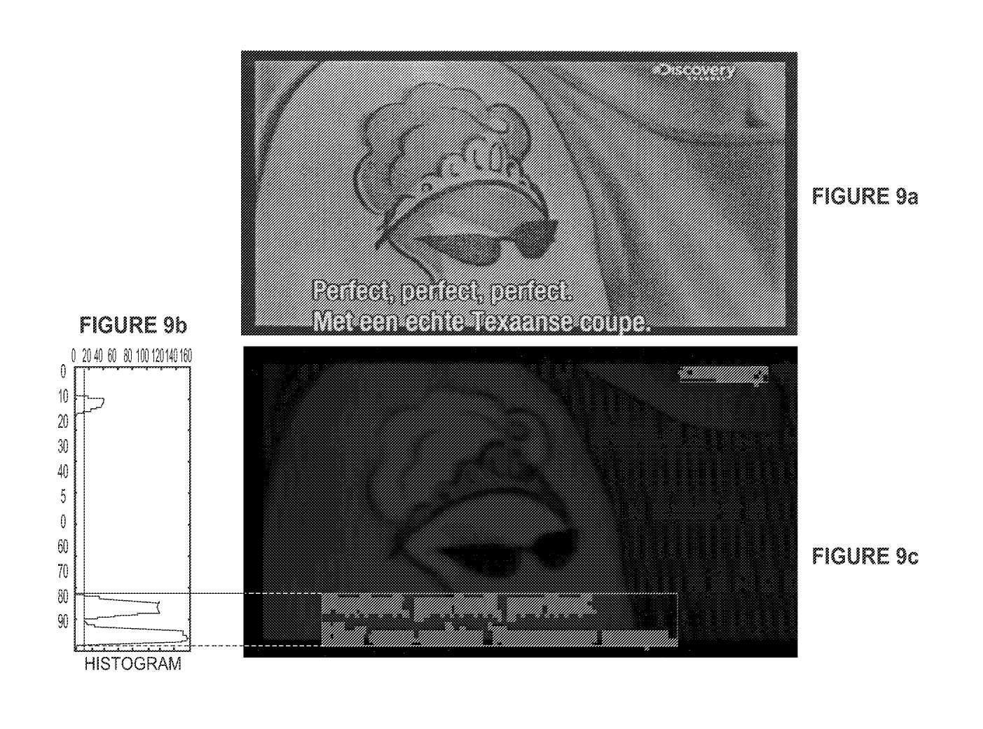

In some cases, even iterative bi-projection cannot split two vertically stacked subtitle lines. In FIG. 9, the value of the horizontal projection of the pruned static regions between the two subtitle lines exceeds the fixed threshold in use, which prevents the two lines from being divided. FIG. 9a is an input image, FIG. 9b is a histogram computed through horizontal projection over the entire image (fixed threshold is marked as a red line through histogram) and FIG. 9c shows bounding boxes computed through iterative bi-projections with fixed thresholds (the two subtitle lines cannot be separated because the static pixels between exceed the fixed threshold).

It is a plausible assumption that the number of static pixels (in pruned static region map) between two subtitle lines is proportional to the horizontal width of the subtitle lines (the wider the subtitle lines, the more spurious pixels may exist in between the two subtitle lines). Based on this assumption, the method implements the following adaptive threshold to improve separation of subtitle lines.

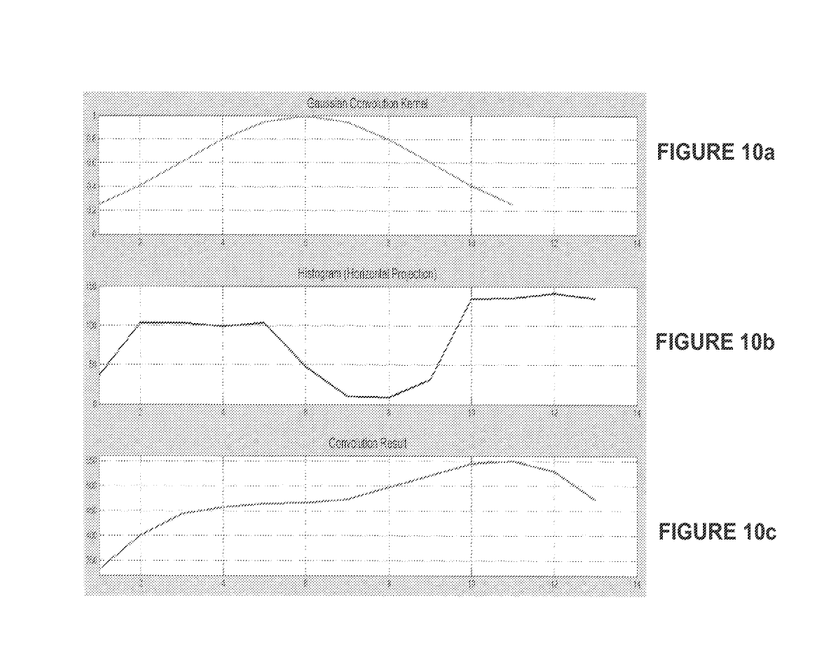

The method defines a Gaussian convolution kernel with a width of approximately two-subtitle-line height as illustrated in FIG. 10(a). We convolute the histogram of horizontal projection (FIG. 10 (b)) with the pre-defined kernel. The convolution result, depicted in FIG. 10 (c), is then multiplied by a fixed factor and serves as the adaptive threshold, and applied on the histogram.

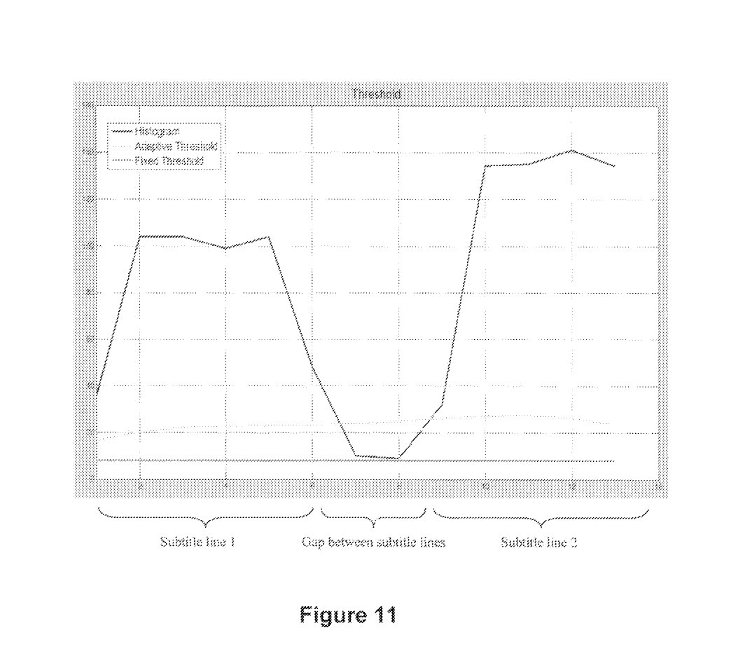

FIG. 11 shows the histogram of horizontal projection corresponding to the subtitle region of the image shown in FIG. 9(a), and the fixed and the adaptive threshold levels. It can be seen that the adaptive threshold is content dependent and is, in this case, higher than the fixed threshold, and goes above the value of the histogram of horizontal projection at the position corresponding to the gap between the two subtitle lines. The adaptive threshold is therefore more effective in detecting the discontinuities in horizontal projection.

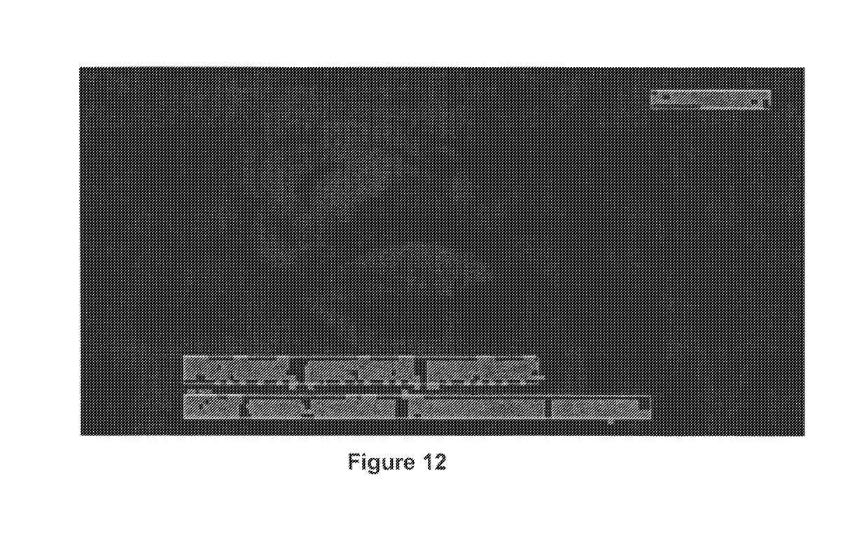

FIG. 12 shows the improved bounding box computation resulting from using the adaptive threshold. To be complete, we mention that, the first bi-projection uses the fixed threshold, and all other iterations of bi-projection use the adaptive threshold.

Categorizing Bounding Boxes

In this step, the method categorizes each bounding box to standard or non-standard, based on bounding box geometry (height) and the filling degree of the pruned static regions within the bounding box.

If the height of the bounding box exceeds a pre-defined threshold, the bounding box is considered to be non-standard (marked with pink in the images of this report). If the filling degree of the pruned static regions within the bounding box is under a pre-defined threshold, the bounding box is considered to be non-standard (marked with blue in the images of this report). In other cases, the bounding box is considered as standard (marked with green in the images of this report).

Adaptive Temporal Filtering

The property of temporal uniformity of subtitles was mentioned which means that subtitles remain stable on the screen for a minimum number of frames, while the background may change during this period. Even though the our static region detector uses temporal information to verify the stillness of the location of sharp luminance transitions, this temporal filtering is performed on pixel level only. Since the method has access to bounding box information, we propose to perform a more advanced temporal filtering, which adapts its filtering strength based on the position of each pixel. The method enables strong temporal filtering on the pixels within a bounding box, while allowing a quick response (weak temporal filtering) for pixels outside bounding boxes. Such adaptive temporal filtering improves the spatial and temporal stability of the computed bounding boxes.

The method is particularly applicable to the TV applications, which are implemented in a real-time streaming video processing computation environment, where accessing data of multiple frames is costly. For this reason, the method uses a strategy that requires access to the pruned static region map of the current frame (frame n) only. Of older frames, the method only needs to remember the bounding box list of frame n□1, and the temporally filtered version of the pruned static region map of frame n□1. This information is sufficient for computing the temporally filtered pruned static region map of the current frame (frame n), on which the bounding box computation is performed. Below we specify the required steps for the temporal filter.

a. Multiply the pruned static region map with a factor of 255, in order to increase the computation precision (all the pixel value of the temporal filtered pruned static region map range from 0 to 255, where 255 means a static pixel with 100% certainty).

b. Let the standard bounding box BB computed on temporally filtered pruned static region map of frame n□1 be labeled with its horizontal and vertical boundary positions as BBn−1^{[h1,h2,v1,v2]}. Further, let TPᵢⱼ (n−1□) be the temporally filtered version of the pruned static region map of frame n−□1 at location i and j, and let CPᵢⱼ(n) be the pruned static region map of frame n at location i and j. The method calculates the normalized absolute difference NAD between the temporally filtered version of the pruned static region map of frame n−□1 and the pruned static region map of frame n as

$$NAD = \frac{{\sum }_{{{h}_{1} \leq i \leq {h}_{2}}_{{v}_{1} \leq j \leq {v}_{2}}} \vert {TP}_{ij} ( n - 1 ) - {CP}_{ij} ( n ) \vert}{( {h}_{2} - {h}_{1} + 1 ) ( {v}_{2} - {v}_{1} + 1 )}$$

$$0 \leq {TP}_{ij} \leq 255$$

$${CP}_{ij} = 0 or 255$$

c. Determine the adaptive temporal filter coefficient α as

$$α = \{ \begin{matrix}0.1 & NAD \leq 25 \\ 0.1 + 0.032 ( NAD \text{-} 25 ) & 25 < NAD \leq 50 \\ 0.9 & NAD > 50\end{matrix}$$

d. Compute the temporally filtered pruned static region map of frame n^{TP ij}(n) at location i and j, as:

$${TP}_{ij} ( n ) = \{ \begin{matrix}α {CP}_{ij} ( n ) + ( 1 + α ) {TP}_{ij} ( n - 1 ) & i , j ∈ [ {h}_{1} - dh , {h}_{2} + dh , {v}_{1} - dv , {v}_{2} + dv ] \\ {CP}_{ij} ( n ) & i , j ∉ [ {h}_{1} - dh , {h}_{2} + dh , {v}_{1} - dv , {v}_{2} + dv ]\end{matrix}$$

e. Store the temporally filtered pruned static region map of frame n^{TP ij}(n) to be used in the next frame.

f. Binarize the temporally filtered pruned static region map of frame n^{TP ij}(n) for bounding box computation of frame n.

In step d of the above procedure indicates that if a pixel lies within or in the vicinity of (dh or dv pixels away from) a bounding box, a first order temporal filter with filter coefficient α is applied, were a high a value means a quick adaptation to the pruned static region map of the current frame, and a low a value means a slow adaptation to the static region map of the current frame. Furthermore, step d prescribes that if the pixel does not lie within or in the vicinity any bounding box, no temporal filtering is applied (the pruned static region map of current frame is used).

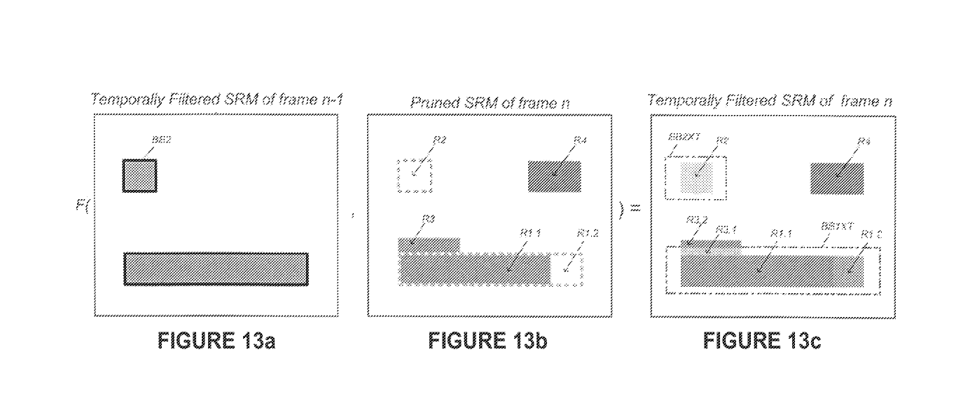

The adaptive temporal filter accounts for different situations that may occur in a video, using the schematic illustration FIG. 13. The goal of the adaptive temporal filter is to facilitate (1) a quick response to an appearing subtitle such that it is detected from the first frame, (2) a strong temporal filtering within the subtitle bounding box for subsequent frames, in order to suppress undesired variations in the computation of the bounding box, and (3) a quick response to a disappearing subtitle in order to ensure the bounding box is not kept after the subtitle disappears.

Region R4 in FIG. 13b represents pruned static region area that appears in frame n, and did not exist in frame n−1 (a new static region area). Since the corresponding area in frame n−1 was not within or in the vicinity of any bounding box, this region is not temporally filtered (see step d above) and takes the value of the pruned static region of frame n. This quick response to appearing static regions ensures that subtitles are detected as soon as they appear.

FIG. 13(a)-(c) are schematic Illustration of Adaptive Temporal Filtering: (a) Temporally filtered static region map of frame n−1, (b) Pruned static region map of frame n, (c) Resulting temporally filtered static region map of frame n.

FIG. 13 (a) shows the temporally filtered pruned static region map of frame n−1 (previous frame), in which two standard bounding boxes BB1 and BB2 are computed. BB2 represents a typical subtitle with clean background. In comparison, FIG. 13 (b) represents the pruned static region map of frame n (current frame), in which region corresponding to BB of previous frame is denoted by a region R1.1 that still contains the subtitle, and a region R1.2 where the subtitle is erroneously not detected (the pruned static region map 0). Further, region R3 represents non-subtitle pixels in the pruned static region map, due to complex background, etc. After computing the difference between the temporally filtered pruned static region map of previous frame and the pruned static region map of the current frames within bounding box BB1 the method obtains a low temporal filter coefficient α, since the relative amount of change is small (R1.2 is much smaller than the size of BB1). This low α □corresponds to slow adaptation to the information of the current frame. Before filtering, we expand the bounding box slightly to a size denoted by BB1XT in FIG. 13 (c), and then compute the temporally filtered pruned static region map for frame n within this extended region. The aforementioned extension facilitates a better suppression of noisy variations around previously computed bounding boxes, since the low filter coefficient of the bounding box is applied to its extended surrounding (R1.2 and R3.1 in FIG. 13 (c)).

In FIG. 13 (a), BB2 represents a bounding box computed in frame n−1 over the last frame of a subtitle area, which disappears in frame n. The corresponding location of BB2 in frame n is denoted by region R2 in FIG. 3.13 (b), where the pruned static regions are lost. After computing the difference between the temporally filtered pruned static region map of previous frame and the pruned static region map of the current frames within bounding box BB2 we obtain a high temporal filter coefficient α, since the relative amount of change is large (R2 is almost as large as BB2). This high a corresponds to quick adaptation to the information of the current frame. This quick adaptation means that we are able to detect the disappearance of subtitles without any frame delay.

After temporal filtering, the result of bounding box computation is significantly improved. On a single frame it leads to higher bounding box accuracy, and on multiple frames of video, it yields a more stable bounding box computation. We illustrate this by the following sample result.

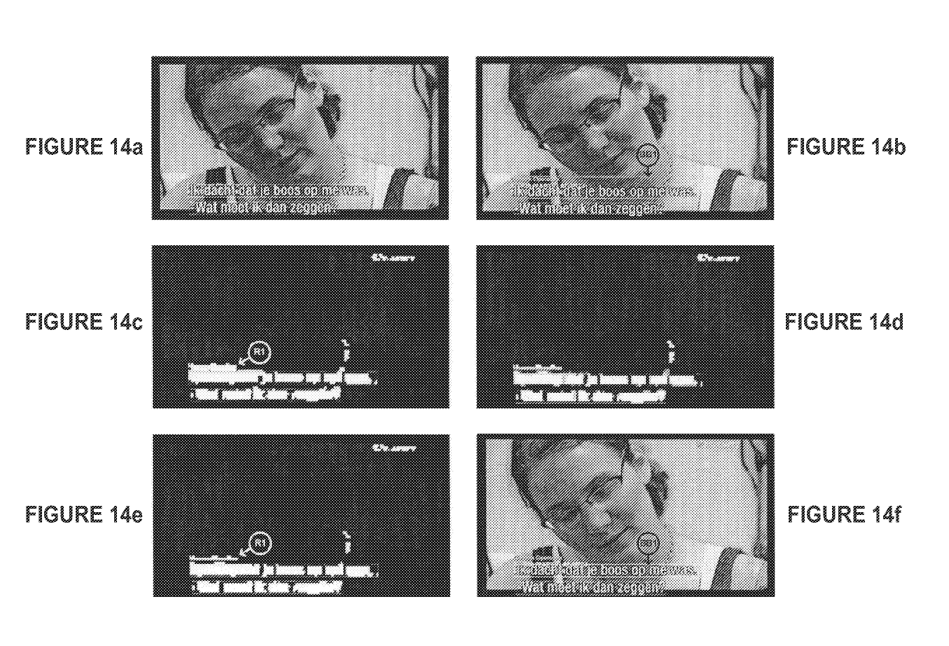

In FIG. 14, (a) shows the result of bounding box computation on frame n−1 without temporal filtering, (b) shows the result of bounding box computation on frame n without temporal filtering, (c) shows the pruned static region map of frame n, (d) shows the temporally filtered pruned static region map of frame n, (e) shows the binarized version of the temporally filtered pruned static region map of frame n, and (f) shows the result of the final bounding box computation using the above binarized map. Comparing (c) and (e), we can see that temporal filtering suppresses the non-subtitle background text (denoted as R1). Comparing (b) and (f), we can see that the temporal filtering improves the accuracy of bounding box computation (denoted by BB1). The final bounding box (f) is tightly fit around the actual subtitle region thanks to our adaptive temporal filtering.

Text Stroke Alignment Features

Despite using constraints such as geometry and filling degree for categorizing bounding boxes, as described above, non-subtitle areas in the pruned static region map that have similar properties of size and filling-degree as subtitles will be categorized as standard bounding box. Therefore, the method needs other subtitle-specific features in order to reject non-subtitle bounding boxes. The method uses a pair of vertical and horizontal text stroke alignment features that helps classify subtitle bounding boxes.

Observing subtitles, it can noticed that text strokes have a few frequently occurring spatial orientation. In typically used Latin subtitle fonts, vertical strokes usually dominate the subtitle text. This spatial orientation is a feature that could be used to distinguish subtitles from other areas that contain high-contrast static edges.

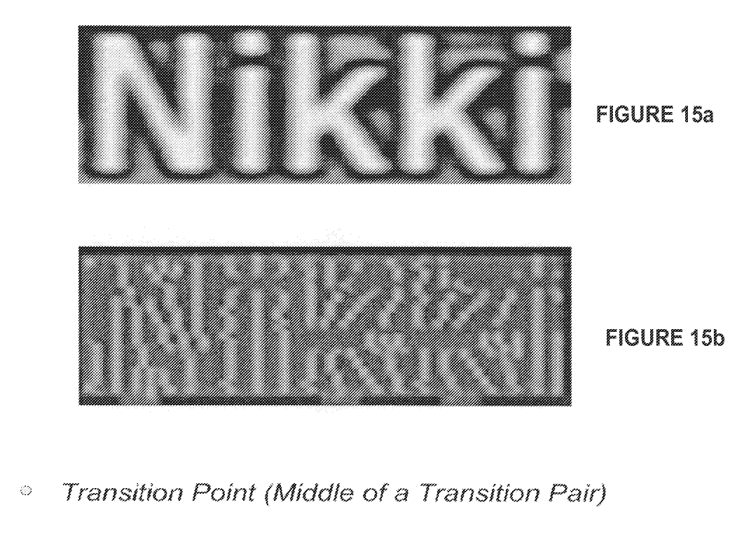

In order to measure the above-mentioned spatial orientation, the method uses the previously developed transition pairs. Recall the horizontal transition pair above. FIG. 15 (b) shows the middle (transition points) of rising-followed-by-falling and falling-followed-by-rising transition pairs in light green dots. It can be noticed that these horizontal transition points are vertically well aligned. This especially holds for the transition points corresponding to rising-followed-by-falling transition pairs (located in the middle of each vertical text stroke), since they are less influenced by the surrounding background. Based on this observation, the method computes the text stroke alignment features as follows.

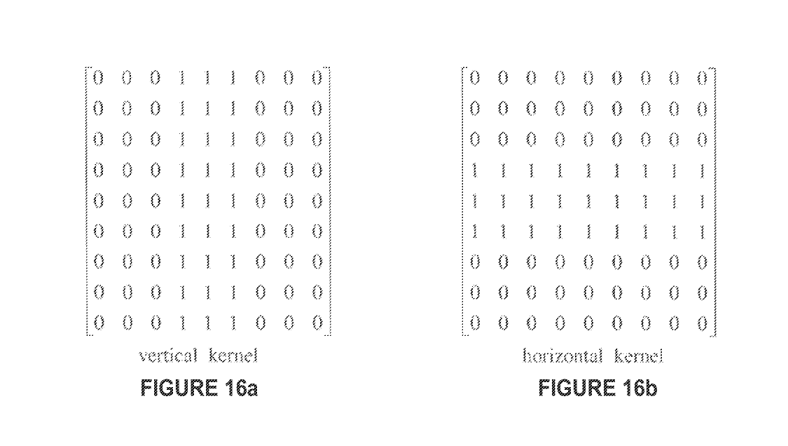

The method first defines the vertical text stroke alignment feature. To start with, the method computes horizontal transition pairs and create a transition center map that has a value of ‘1’ at spatial location corresponding to the middle (transition point) of rising-followed-by-falling transition pairs, and a value of 0 elsewhere. Next, 2D vertical kernel may be convolved with this transition center map in order to measure the vertical alignment of horizontal transition points. The vertical kernel is depicted in FIG. 16(a). Finally, the method computes the vertical stroke alignment feature of a bounding box by averaging the convolution result over of the pixels within the bounding box.

The following procedures specify the steps for computing the vertical stroke feature further.

a. Apply a horizontal gradient filter on the input image to obtain sharp rising and falling edges. Sharp is quantified as a gradient of intensity bigger than 20 over two horizontally adjacent pixel.

b. Find closely-located rising-followed-by-falling edge pairs and mark them as transition pairs. Denote a transition point for each transition pair as the middle of corresponding rising and falling edges. Notice that unlike 3.2, only rising-followed-by-falling edge pairs are treated.

c. Convolute the transition map with the pre-defined vertical kernel. Denote VAᵢⱼ as the convolution results for pixel (i, j).

d. For a standard bounding box labeled as [h₁,h₂,v₁,v₂], calculate the vertical stroke alignment feature VF as

$$VF = \frac{{\sum }_{{{h}_{1} \leq i \leq {h}_{2}}_{{v}_{1} \leq j \leq {v}_{2}}} {VA}_{ij}}{( {h}_{2} - {h}_{1} + 1 ) ( {v}_{2} - {v}_{1} + 1 )}$$

The above procedure can be used to compute text stroke alignment in any direction. For Latin font, we found the horizontal stroke alignment feature to be useful. We compute the horizontal stroke alignment by replacing the horizontal gradient filter of step (a) above with a vertical gradient filter, and by replacing the vertical kernel in step (c) above with the horizontal kernel depicted in FIG. 15.

Other orientations, e.g. 45°, 135°, may be useful depending on the language of the subtitles. In our case we found horizontal and vertical stroke alignment features to have a higher distinction power for our test videos.

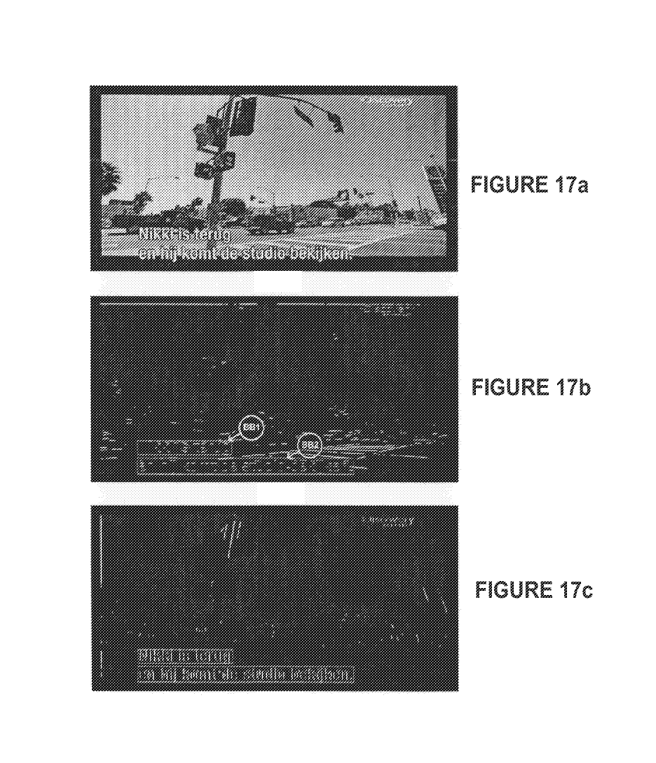

In FIG. 17, (b) shows the result of convolution between the horizontal kernel and the vertical transition map, for the input image. FIG. 17, (c) shows the result of convolution between the vertical kernel and the horizontal transition map for the same frame. After calculation, the horizontal stroke alignment feature of the bounding box BB1 is 0.4807, and the vertical stroke alignment feature is 1.2049. The horizontal and vertical stroke alignment features of the bounding BB2 box are 0.4851 and 1.2250, respectively. The higher value of the vertical stroke alignment corresponds with the facts that the subtitle contains more vertical strokes than horizontal strokes.

Bounding Box Classification

The text stroke alignment features described above are used for classifying the standard bounding boxes to either a subtitle bounding box, or a non-subtitle bounding box. In this section, the classification procedure is described, which includes training and model parameter estimation using a training set, and also measure the performance of the classifier using a test set.

For training and testing the classifier, we use two videos with similar subtitle fonts, with a total length of around 10700 frames. These sequences have been recorded from a TV broadcasting. The method assigns roughly half of both sequence (around 5500 frames) as training set, and use the other half of both sequences (around 5200 frames) as test set used for measuring the performance of the classifier.

Training the Classifier

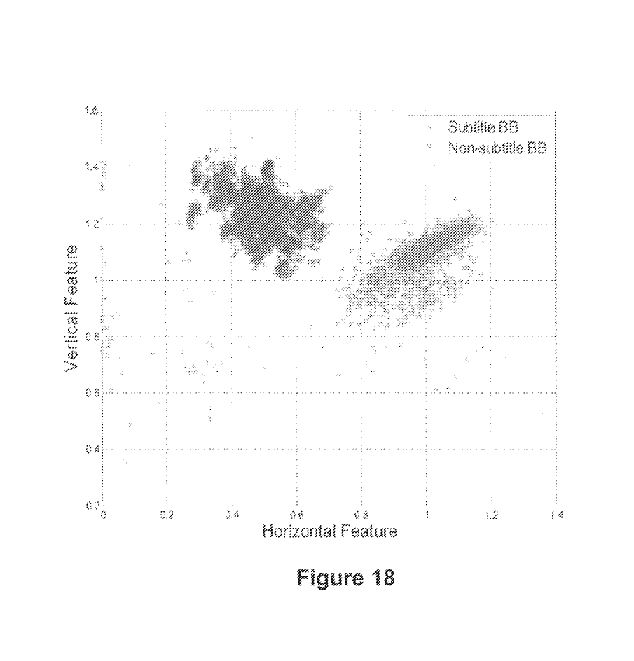

As a first step, the distribution of the horizontal and vertical text stroke alignment features is investigated (referred to as features in the remainder of this section). This requires manual annotation of the detected standard bounding boxes to either subtitle or non-subtitle classes. To this end, we compute the standard bounding boxes for the training set, and then manually mark each bounding box as either subtitle or nonsubtitle bounding box. For all bounding boxes, we calculate the two features. FIG. 18 visualizes the distribution of these features for the manually annotated subtitle and non-subtitle bounding boxes.

Observing the compactness of distribution of the features of the subtitle class in FIG. 18, the method may model this distribution with a 2-D Gaussian Model.

The probability density function for our 2-D Gaussian model is defined as

$$p ( {x}_{n} \vert μ , Σ ) = {\vert 2 πΣ \vert}^{- \frac{1}{2}} exp ( - \frac{1}{2} {( {x}_{n} - μ )}^{T} {Σ}^{- 1} ( {x}_{n} - μ ) )$$

where μ□ is the mean value, Σ□ is the covariance matrix and ∥ denotes the determinant. The model parameter μ and Σ□ may be estimates from the data by: 0

$$\hat{μ} = \frac{1}{N} {\sum }_{n} {x}_{n} , \\ = \frac{1}{N} {\sum }_{n} ( {x}_{n} - \hat{μ} ) {( {x}_{n} - \hat{μ} )}^{T} .$$

For our training set, the model parameters are computed to be

$$\hat{μ} = [ 0.48265433 , 1.23491908 ] , \\ = [ \begin{matrix}0.00579171 & - 0.00151139 \\ - 0.00151139 & 0.00472253\end{matrix} ] .$$

Having computed the model parameters, the probability of each bounding box belonging to the subtitle class may be calculated based on its pair of horizontal and vertical alignment features, and the 2D Gaussian model. Since we are interested in a binary classification to either of the two classes, this probability needs to be thresholded. In the following, we explain how the threshold level is determined.

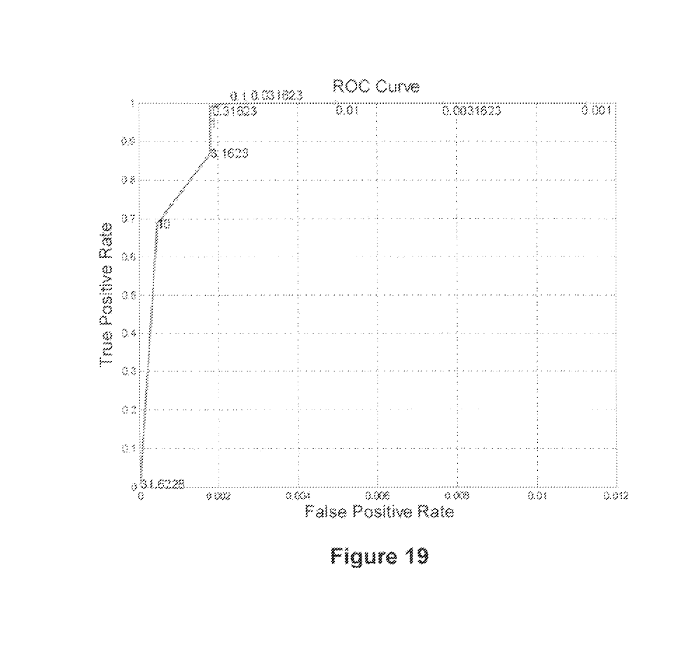

Using the result of the 2D continuous Gaussian model and the manual annotations, we first compute the Receiver Operating Characteristic curve (ROC curve). From the ROC curve in FIG. 19, the True Positive rate and False Positive rate of different threshold levels can be visualized.

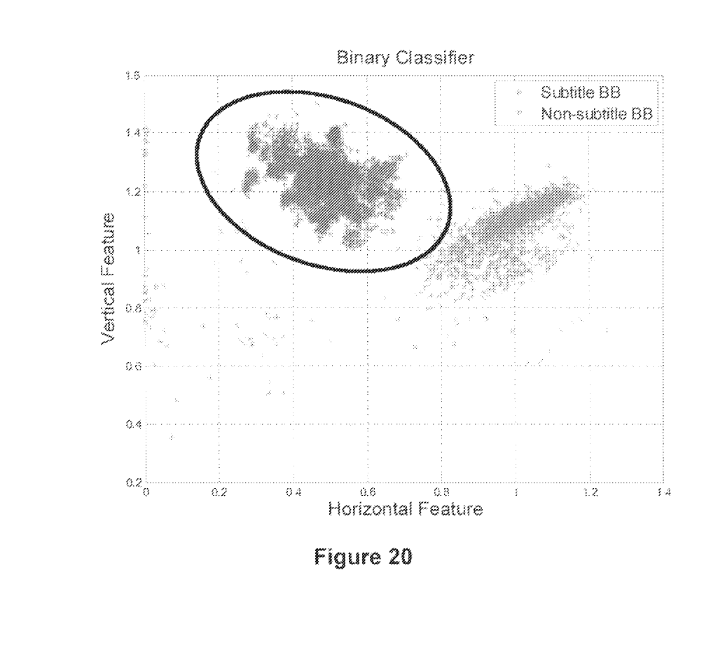

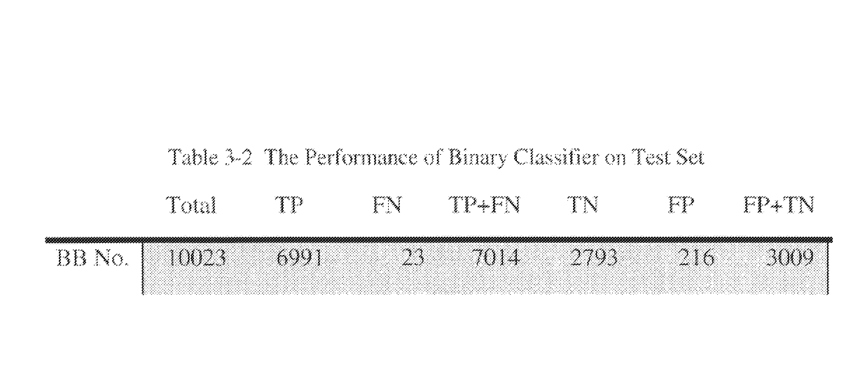

We determine suitable set of requirements as follows. The True Positive rate must reach at least 99.9% and the False Positive Rate may not exceed 1%. That is to say, at least 99.9% of subtitle bounding boxes should be correctly classified as subtitle, and at most 1% non-subtitle bounding boxes could be mistakenly classified as subtitle bounding box. The optimal threshold that fulfils the requirement is 0.00133307. This threshold level cannot be seen in FIG. 19, but is shown in FIG. 20 as a black ellipse. Note that the selected threshold fulfills the requirements on the training set. The requirements may not be fulfilled in the test set.

Testing the Classifier

We mentioned previously that we reserve half of the available frames as a test set. Applying the classifier on the test set, we obtain detection result illustrated in Table 3-2, which indicates that 99.67% of the subtitle bounding boxes correctly classified (retained), while 93.82% non-subtitle bounding boxes are rejected.

$$T P R = \frac{TP}{TP + FN} = \frac{6991}{7014} = 0.99672084$$

$$F P R = \frac{FP}{TN + FP} = \frac{216}{3009} = 0.07178464$$

The above measurement shows the superior discrimination power of our features and classifier for differentiating between subtitle and non-subtitle bounding boxes.

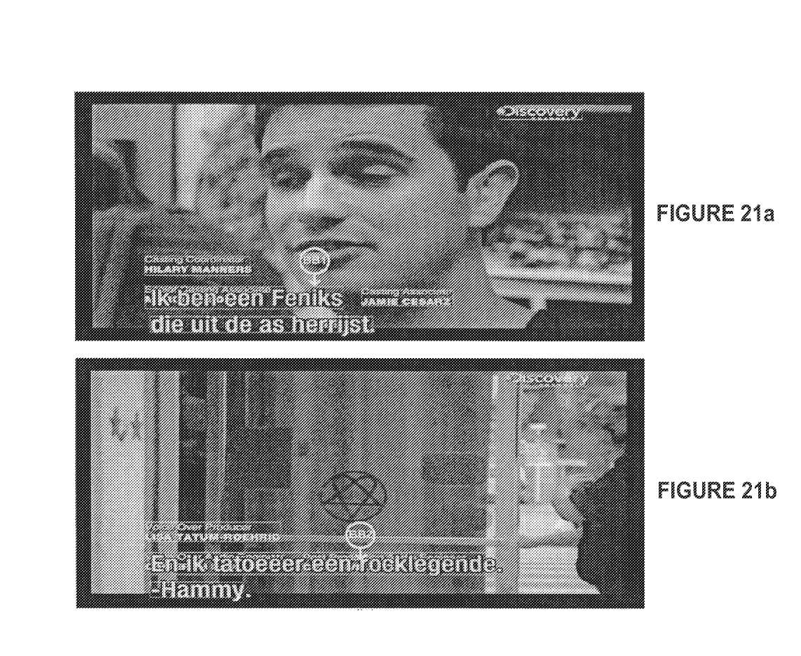

It is essential that we do not reject bounding box that actually containing subtitle. Hence we further check the bounding boxes that were mistakenly classified as non-subtitle. As can be seen in FIG. 21, in our test set, these misclassified subtitle hounding boxes contain not only subtitle but also other nonsubtitle characters with smaller fonts, which affect the calculated alignment features of the bounding box.

It needs to be mentioned that this classifier is sensitive to the font and size of subtitle characters, and hence it is important to use a training set that contains all desired subtitle, fonts and sizes.

Summary of the Subtitle Detection Method and System

Here follows a summary of the system and method for subtitle detection.

The first step is to compute static region map on the video. The Matlab implementation of the method operates on a (Pfspd) video file on which the static region map is already computed. Next, the method computes horizontal transition pairs over the image, select regions, with high density of transition pairs and use this to prune the static region map. Then the method performs adaptive temporal filtering on the pruned static region map to reduce variation in the pruned static region map. This efficiently integrates information from multiple frames. Thereafter the method roughly locate subtitles by generating standard bounding boxes using iterative horizontal and vertical projections. Finally, for each standard bounding box, the method computes a pair of horizontal and vertical text stroke alignment feature, and use this to carry out a binary classification of the standard bounding box to subtitle or non-subtitle classes, based on a trained 2D Gaussian model.

Result of the Method on Test Patterns

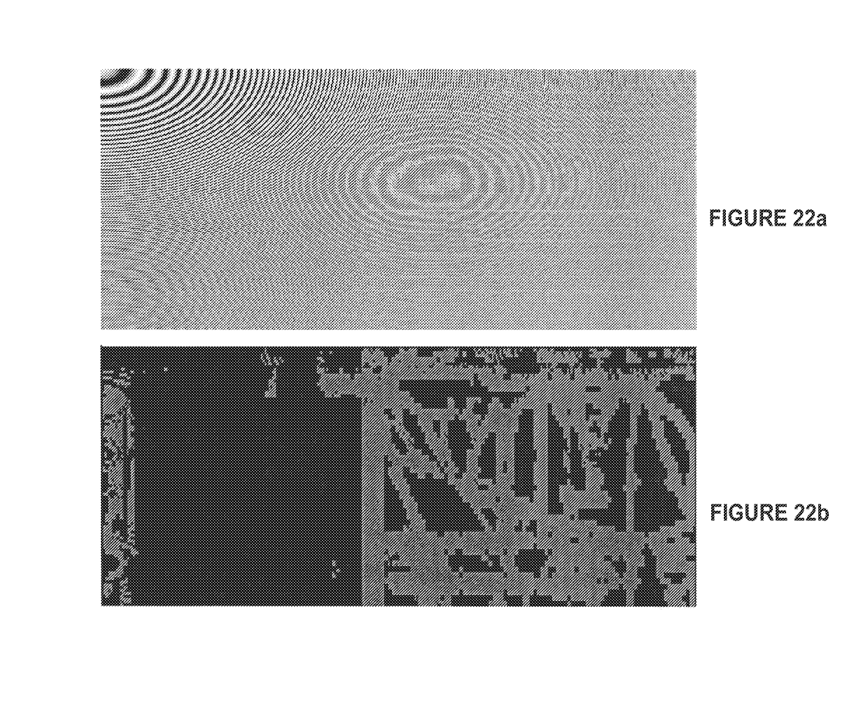

Synthetic test patterns are used for evaluating the quality and shortcomings of TV image processing functions. These test patterns usually contain sharp repetitive high frequency edges, which is detected by the static region detector as static regions. In moving test patterns, this misdetection could result in unacceptable artifacts after frame-rate up-conversion. Therefore, we present here the result of the proposed subtitle detection on the well-known Zoneplate test pattern, shown in FIG. 22(a), to verify whether our algorithm effective in rejecting the pseudo-stationary regions of this test sequence. The sequence contains multiple frames with a pattern identical to the one depicted in FIG. 22(a), except that spatial phase of the pattern increases in consequent frames (resulting in a moving pattern).

FIG. 22 (b) shows the result of static region detection on this frame, where gray indicates static regions. It can be seen that the static region detector erroneously identifies most of the moving regions as static. Overlaid on FIG. 22(a) we can see the result of bounding box computation in colored rectangles, where blue and pink rectangles indicate a non-standard bounding box, and a red rectangle indicates a non-subtitle standard bounding box. The existence of the red rectangles indicates that even after pruning, temporal filtering and categorizing the bounding boxes according to subtitle geometry and filling degree, many bounding boxes are categorized as standard. This is because the sharp texture of the Zoneplate pattern resembles that of subtitle text. However, after computing text stroke alignment feature and classification, all of the standard bounding boxes are finally classified as non-subtitle bounding box (we do not see a green rectangle in FIG. 22(a)). This shows that the proposed method can effectively classify typically used high frequency synthetic test patterns, such as the Zoneplate, as non-subtitle.

Application

The above described subtitle detection system and method may be used to remove unintended artifacts in the up-converted video. Foremost, the subtitle detection method could be potentially extended to provide a pixel-level segmentation of subtitle pixels. This level of information could be used to guide the motion estimator such that the motion vectors of the background are not disturbed by the overlaid subtitle. Alternatively, we could remove (or fill) the subtitle pixels accurately before frame-rate up-conversion and overlay the subtitle pixels back on the up-converted video. Previously performed experiments have shown that this procedure could significantly reduce the artifacts around subtitle in the frame-rate upconversion. Due the subjective visual importance of subtitles, this reduction in artifacts could greatly improve the quality of up-converted videos.

We also showed above, the method is effective in rejecting patterns that have high spatial frequency, such as a moving Zoneplate. This kind of pattern has the tendency to appear static to the static region detector, causing unacceptable artifacts after frame-rate up-conversion. The result above shows that the proposed subtitle detection method can effectively classify such pseudo-static regions as non-subtitle. This object-level information can be used for preventing artifacts in such cases.

While the foregoing has been with reference to particular embodiments of the disclosure, it will be appreciated by those skilled in the art that changes in this embodiment may be made without departing from the principles and spirit of the invention, the scope of which is defined by the appended claims.

1. A method for determining a subtitle in video, comprising:
detecting a static region in a video to generate a pruned static region map; and
performing adaptive filtering on the pruned static region map to identify a bounding box of a subtitle candidate, wherein the adaptive filtering adjusts the filter coefficients differently for areas within or in the neighborhood of the bounding box than for areas outside or far away from the bounding box; and
computing a set of features of the bounding box of the subtitle candidate to determine the bounding boxes of the subtitle.

2. The method of claim 1, wherein performing adaptive filtering further comprises performing adaptive filtering with an adaptive temporal filter and wherein adjusting the filter coefficients further comprises adjusting temporal coefficients of the adaptive temporal filter.

3. The method of claim 1 that is used for one of motion compensated frame-rate up-conversion, 3D positioning of subtitles in 3D TV and image enhancement operations with specific settings of subtitles.

4. A system for determining subtitles in video, comprising:
a static region detector that detects a pruned static region in a video and generates a pruned static region map;
an adaptive filtering unit, coupled to the static region detector, that performs adaptive temporal filtering on the pruned static region map to identify a bounding box of a subtitle candidate, wherein the adaptive filtering adjusts the filter coefficients differently for areas within or in the neighborhood of the bounding box than for areas outside or far away from the bounding box; and
a bounding box classifier that computes a set of features of the bounding box of the subtitle candidate to determine the bounding boxes of the subtitle.

5. The system of claim 4, wherein the adaptive filtering unit further comprises an adaptive temporal filter unit that adjusts temporal coefficients of the adaptive temporal filter.

6. The system of claim 4, wherein the system is used for one of motion compensated frame-rate up-conversion, 3D positioning of subtitles in 3D TV and image enhancement operations with specific settings of subtitles.
